(19) United States
(12) Patent Application Publication
(10) Pub. No.: US 2010/0269764 A1
(43) Pub. Date: Oct. 28, 2010

(54) COLLAR AND LEASH ASSEMBLY

(76) Inventor: Hansen Rogers, Greenwell Springs, LA (US)

Correspondence Address: WARNER J DELAUNE JR;Baker Donelson Bearman Caldwell & Berkowitz, Chase North Tower, 450 Laurel Street, 20th Floor, Baton Rouge, LA, 70801, US

(21) Appl. No.: 12/430,204

(22) Filed: Apr. 27, 2009

(51) Int. Cl. A01K 27/00

(52) U.S. Cl. 119/797; 119/795; 119/863

(57) ABSTRACT

A collar and leash assembly is provided, comprising a strap, preferably constructed from nylon or similar fabric, having a first end and a second end, wherein the first end includes a first fastener, and wherein the second end includes a second fastener. A loop is formed into the first end of the strap, and the loop is closed adjacent to the first fastener. A third fastener is slidably connected to the loop of the strap, and a fourth fastener is slidably connected to the strap between the loop and the second end. Preferably, a releasable clip is slidably connected to the loop for optional connection to an existing animal collar. The strap can be configured into a long leash, short leash, or collar configuration depending upon the connections between the various fasteners.

### CROSS-REFERENCE TO RELATED APPLICATIONS

Not applicable.

### STATEMENT REGARDING FEDERALLY SPONSORED RESEARCH OR DEVELOPMENT

Not applicable.

### THE NAMES OF THE PARTIES TO A JOINT RESEARCH AGREEMENT

Not applicable.

### INCORPORATION-BY-REFERENCE OF MATERIAL SUBMITTED ON COMPACT DISC

Not applicable.

### BACKGROUND OF THE INVENTION

1. Field of the Invention

This invention relates to collars and leashes used to restrain pets, and more particularly to adjustable leashes and collars which can be adjusted in multiple configurations for use with dogs.

2. Description of Related Art

The use of dog collars and leash systems of known designs and configurations is understood in the prior art. More specifically, dog collars and leash systems of known designs and configurations previously devised and utilized for the purpose increasing dog safety, control and convenience are known to consist basically of familiar, expected, and obvious structural configurations, notwithstanding the myriad of designs encompassed by the crowded prior art which has been developed for the fulfillment of countless objectives and requirements.

By way of example, the following patents are examples of dog collars and leashes which are representative of the state of the art: U.S. Pat. No. 7,243,615 (Hendrie), U.S. Pat. No. 7,103,943 (Lambert), U.S. Pat. No. 6,880,490 (Hanna), U.S. Pat. No. 6,851,393 (Bremm), U.S. Pat. No. 6,367,428 (Forte), U.S. Pat. No. 5,806,467 (Arakawa), U.S. Pat. No. 5,791,295 (Schmid), U.S. Pat. No. 5,749,325 (Albanese), and U.S. Pat. No. 5,456,213 (Beauchamp). Of the aforementioned devices, none of the prior art discloses the use of a single strap having multiple quick-release buckles, which can be configured into a collar, a short leash, and a long leash depending on the needs of the user. The prior art collars and leashes typically require two or more straps and numerous stitchings to accomplish their purposes, but still not achieving the goal of functioning as a collar and a 2-position leash.

What is needed, there is a multiple-use collar and leash assembly which requires a single strap and a minimum number of connective stitchings so that maximum utility may be obtained with a minimum of effort and expense. As will be appreciated from the following description of the preferred embodiments, the present invention is not only superior to the prior art with respect to multiple configurations, but is also exceptionally easy and cost effective to manufacture. Furthermore, the foregoing advantages are realized concurrently with improved dog safety, control, and convenience.

### SUMMARY OF THE INVENTION

What is needed, there is a multiple-use collar and leash assembly which: (a) is simple to use and adjust, (b) is capable of being configured into two distinct leash lengths, (c) provides the user with reliable fastening and control of the animal, (d) can be worn on the animal as a collar when not in either of the leash configurations, and (e) is comfortable and light-weight for the animal.

According a collar and leash assembly is provided, comprising a strap, preferably constructed from nylon or similar fabric, having a first end and a second end, wherein the first end includes a first fastener, and wherein the second end includes a second fastener; a loop formed into the first end of the strap, wherein the loop is closed adjacent to the first fastener, preferably by stitching; a third fastener slidably connected to the loop of the strap; and a fourth fastener sidably connected to the strap between the loop and the second end. Preferably, a releasable clip is slidably connected to the loop for optional connection to an existing animal collar.

In a preferred embodiment, all of the fasteners are quick release buckles. More preferably, the first fastener is a female quick release buckle, and the second fastener is a male quick release buckle. Likewise, the third fastener is a male quick release buckle, and the fourth fastener is a female quick release buckle.

With respect to the various configurations of the invention, the second fastener may be connected to the fourth fastener to form an adjustable second loop, thereby defining a longer leash configuration.

Alternatively, the second fastener may be connected to the first fastener to form a fixed second loop, thereby defining a short leash configuration. In this short leash configuration, it is preferred that the fourth fastener is positioned on an outer side of the strap, thus facilitating the collar configuration.

Finally, once the device is in the short leash configuration, the fourth fastener may be connected to the third fastener to form a third loop, thereby defining a collar configuration. Ideally, when the device is in the collar configuration, all portions of the third loop of the strap should lay flat against each other for maximum comfort to the animal when worn.

### BRIEF DESCRIPTION OF THE DRAWINGS

For a further understanding of the nature, objects, and advantages of the present invention, reference should be had to the following detailed description, read in conjunction with the following drawings, wherein like reference numerals denote like elements.

FIG. 1 is a perspective view according to a preferred embodiment of the invention in an open configuration.

FIG. 2 is a perspective view of the embodiment of FIG. 1, depicting a long leash configuration.

FIG. 3 is a perspective view of the embodiment of FIG. 1, depicting a short leash configuration.

FIG. 4 is a perspective view of the embodiment of FIG. 1, depicting a collar configuration.

FIG. 5 is a view of the invention deployed with an animal.

### DETAILED DESCRIPTION OF THE PREFERRED EMBODIMENTS

Before the subject invention is further described, it is to be understood that the invention is not limited to the particular embodiments of the invention described below, as variations of the particular embodiments may be made and still fall within the scope of the appended claims. It is also to be understood that the terminology employed is for the purpose of describing particular embodiments, and is not intended to be limiting. Instead, the scope of the present invention will be established by the appended claims.

In this specification and the appended claims, the singular forms “a,” “an,” and “the” include plural reference unless the context clearly dictates otherwise. Unless defined otherwise, all technical and scientific terms used herein have the same meaning as commonly understood to one of ordinary skill in the art to which this invention belongs.

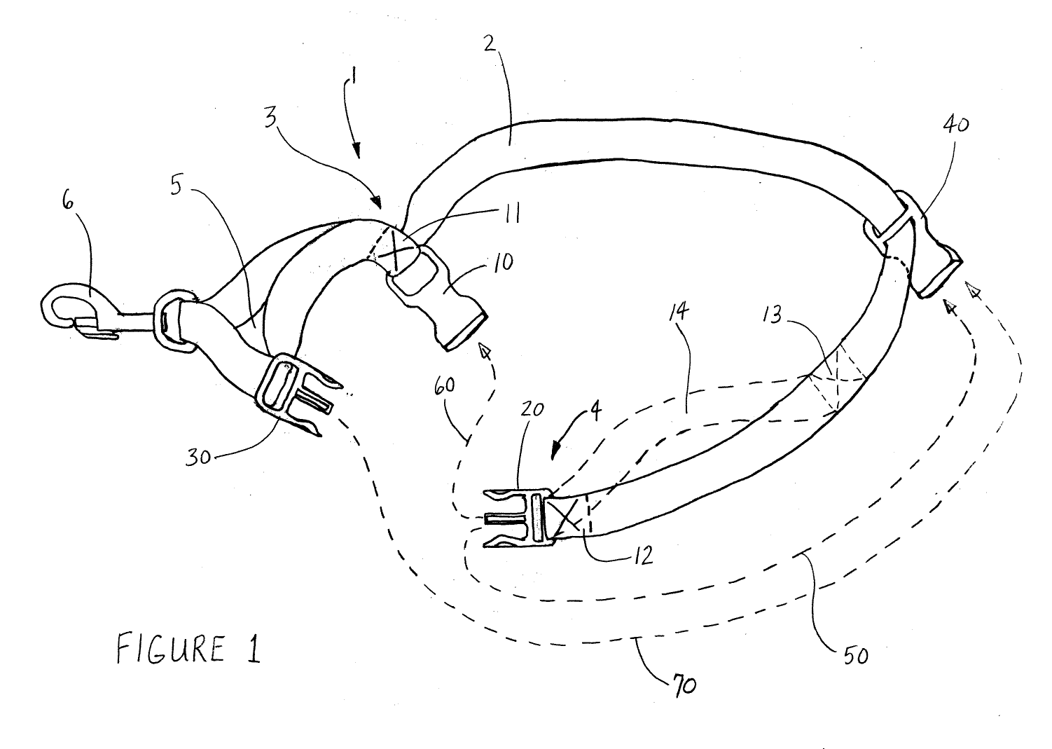

Turning now to FIG. 1, a preferred embodiment 1 of the invention is shown to generally comprise a strap 2, preferably constructed from nylon or similar fabric, having a first end 3 and a second end 4. The raw material for the strap 2 should be approximately 36-38 inches long and having a width that is sized to fit within the fasteners to be used. The first end 3 includes a first fastener 10, and the second end 4 includes a second fastener 20. During assembly of the device, strap 2 is passed through the base of first fastener 10, and then through a releasable clip 6, and then through third fastener 30. The first fastener 10 is then affixed in its position relative to the strap 2 by again passing the strap through first fastener 10 and stitching the strap to itself at stitch 11. Similarly, the second end 4 of the strap is passed through the base of fourth fastener 40, and then through the base of second fastener 20. Second fastener 20 is affixed in its position on strap 2 by attaching the strap to itself at stitch 12. Optionally, the device may be assembled to create an optional loop 14, simply by using a longer strap 2 and placing stitch 12 at a location other than immediately adjacent to the second fastener 20. For example, such an optional loop 14 may be formed by placing stitch 12 near the location identified by phantom lines 13.

By virtue of the assembly described above, a loop 5 is formed into the first end 3 of the strap 2, wherein the loop 5 is closed adjacent to the first fastener 10 by stitch 11. Third fastener 30 is sidably connected to the loop 5, while fourth fastener 40 is slidably connected to the strap 2 between the loop 5 and the second end 4. The releasable clip 6 on loop 5 is also slidably connected to the loop 5 for optional connection to an existing animal collar. As will be appreciated, it is important during the assembly process to thread the third fastener 30, fourth fastener 40, and the releasable clip 6 onto the strap 2 prior to attaching the first and second fasteners 10, 20 to the strap 2. More specifically, it is also important that the third fastener 30 and the releasable clip 6 be positioned along that portion of the strap 2 that is to form loop 5 prior to making the stitch that closes loop 5. Once loop 5 is closed, the third fastener 30 and the releasable clip 6 should be free to slide along loop 5. After forming the loop 5, the remaining portion of strap 2 extends from the first fastener 10, and it is used in the manner as described below. As a further option, loop 5 may be enlarged and configured to be an openable loop by including an additional quick release fastener buckle. In that configuration, loop 5 may then serve as a collar for the animal, while the remainder of the device may serve as the leash.

For reasons which will become apparent in the ensuing description of the collar configuration, it is important that the fourth fastener 40 be positioned in such a manner that it lies on the outer side of the strap 2. In that position, the fourth fastener 40 will remain free to connect to the third fastener 30 without twisting the strap 2 from its preferred flat orientation when worn by the animal.

In a preferred embodiment, all of the fasteners are common plastic quick release (or side release) buckles which are readily available through numerous suppliers. As shown in FIGS. 1-4, and without limiting the many possibilities of fastener types that can be used with equal effectiveness, the first fastener 10 is a female quick release buckle, and the second fastener 20 is a male quick release buckle. Likewise, the third fastener 30 is a male quick release buckle, and the fourth fastener 40 is a female quick release buckle. Furthermore, many quick release fasteners are manufactured with a convex side and a concave side. When assembling the device, the concave side of each fastener component should be oriented along the strap 2 such that when the leash is worn around the neck of the animal, the concave side should conform to the neck.

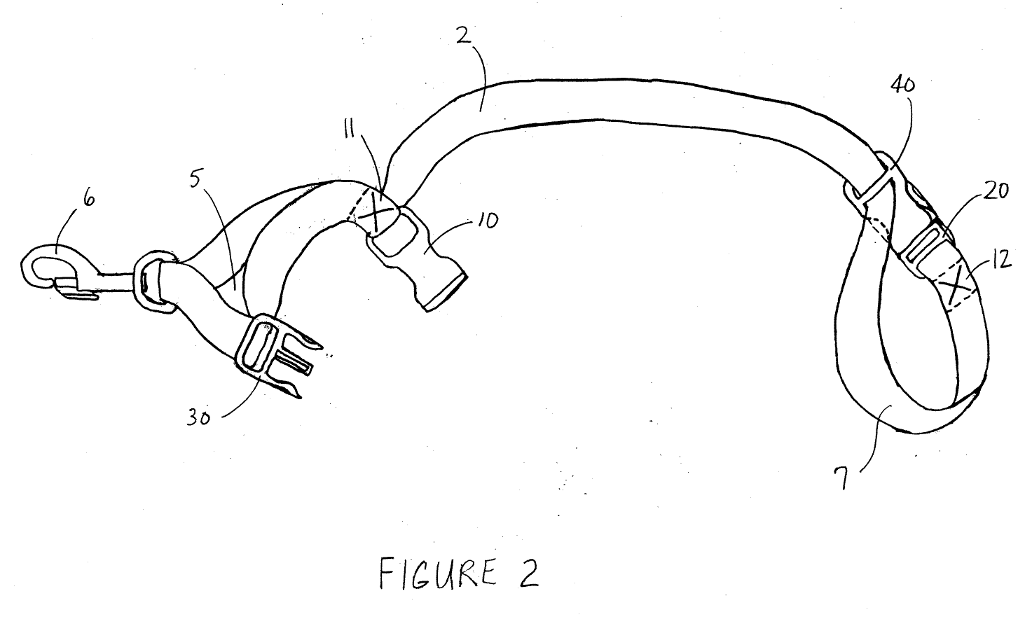

With respect to the various configurations of the invention, a “long leash” configuration may be obtained by connecting the second fastener 20 to the fourth fastener 40, as illustrated in FIG. 1 by the path 50. Because of the slidable attachment of the fourth fastener 40 to the strap 2, the connection forms an adjustable second loop 7, best shown in FIG. 2. Thus, the user may grip the second loop 7 while the releasable clip 6 is attached to a standard collar on the animal, resulting in a leash having roughly an 18-inch length.

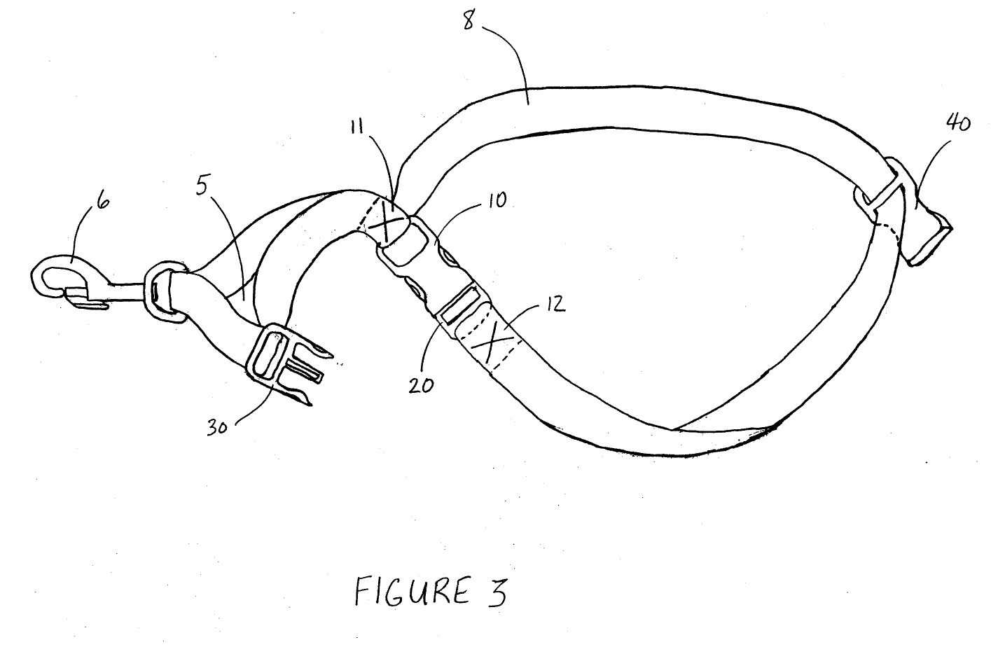

Alternatively, the second fastener 20 may be connected to the first fastener 10 to form a fixed second loop 8, as illustrated in FIG. 1 by the path 60, thereby defining a “short leash” configuration best shown in FIG. 3. In this short leash configuration, and as explained earlier herein, it is preferred that the fourth fastener 40 be positioned on an outer side of the strap 2, thus facilitating the collar configuration described below. Depending upon the exact length of the strap 2, the short leash configuration should result in a leash having roughly a 12-inch length.

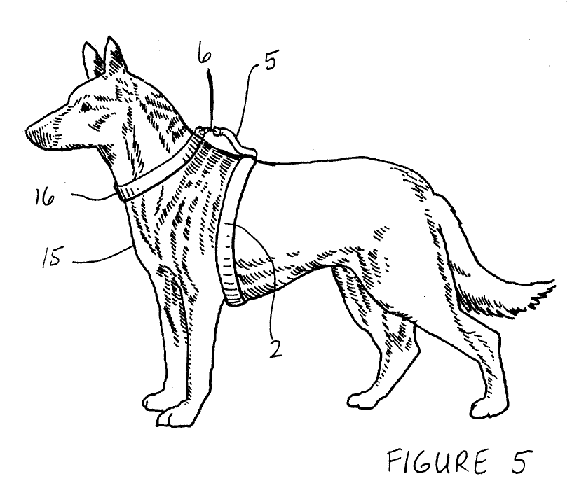

Further in the alternative, the second loop 8 may be conveniently encircled around the chest of a dog 15, as indicated in FIG. 5, while the releasable clip 6 is attached to a standard collar 16. In this manner, the user can grip loop 5 for a close hold on the dog 15 when needed.

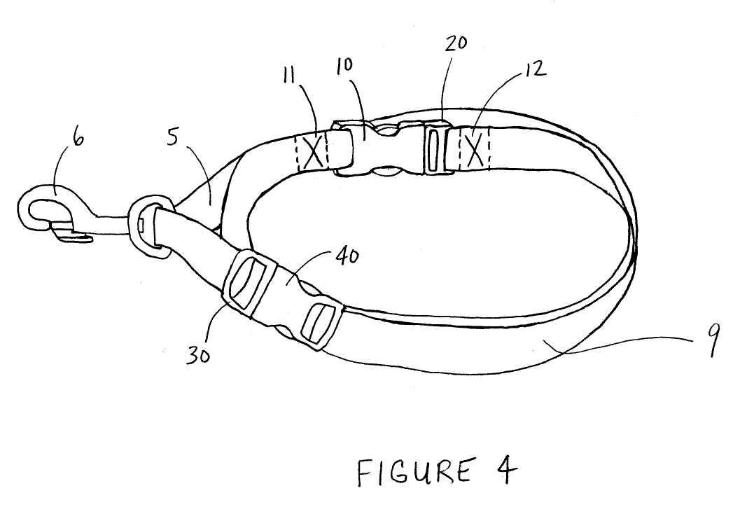

Finally, once the device is in the short leash configuration, the fourth fastener 40 may be connected to the third fastener 30, as illustrated in FIG. 1 by the path 70, to form a third loop 9, thereby defining a collar configuration best shown in FIG. 4. Ideally, when the device is in the collar configuration, all portions of the third loop 9 of the strap should lay flat against each other for maximum comfort to the animal when worn. As will be appreciated, when the collar configuration is employed, the releasable clip 6 may also be used for connection to a standard leash.

Of course, numerous modifications and variations of the present invention are possible in light of the above teachings. It is therefore to be understood that within the scope of the appended claims, the invention may be practiced otherwise than as specifically described herein.

What is claimed is:

1. A multi-purpose collar and leash assembly, comprising:
(a) a strap having a first end and a second end, wherein said first end includes a first fastener, and wherein said second end includes a second fastener;
(b) a loop formed into said first end of said strap, wherein said loop is closed adjacent to said first fastener;
(c) a third fastener slidably connected to said loop of said strap; and
(d) a fourth fastener slidably connected to said strap between said loop and said second end.

2. The device of claim 1, further including a releasable clip slidably connected to said loop.

3. The device of claim 1, wherein said strap is constructed from nylon.

4. The device of claim 1, wherein said first fastener, said second fastener, said third fastener, and said fourth fastener are quick release buckles.

5. The device of claim 1, wherein said first fastener is a female quick release buckle, and said second fastener is a male quick release buckle.

6. The device of claim 1, wherein said third fastener is a male quick release buckle, and said fourth fastener is a female quick release buckle.

7. The device of claim 1, wherein said second fastener is connected to said fourth fastener to form an adjustable second loop, thereby defining a leash configuration.

8. The device of claim 1, wherein said second fastener is connected to said first fastener to form a fixed second loop, thereby defining a leash configuration.

9. The device of claim 1, wherein said second fastener is slidable within a second loop formed in said second end of said strap.

10. The device of claim 1, wherein said loop is opened, and wherein said loop is configured with a fifth closeable fastener to form a collar.

11. The device of claim 8, wherein said fourth fastener is positioned on an outer side of said strap.

12. The device of claim 8, wherein said fourth fastener is connected to said third fastener to form a third loop, thereby defining a collar configuration.

13. The device of claim 12, wherein all portions of said third loop of said strap lay flat against each other.

14. The device of claim 1, wherein said loop is closed by stitching.
